(19) United States
(12) Patent Application Publication
(10) Pub. No.: US 2014/0265047 A1
(43) Pub. Date: Sep. 18, 2014

(54) LASER SINTERING APPARATUS AND METHODS

(71) Applicant: Matterfab Corp., Bloomington, IN (US)

(72) Inventors: Matthew Burris, Bloomington, IN (US); Andrew Dolgner, Bloomington, IN (US)

(73) Assignee: Matterfab Corp., Bloomington, IN (US)

(21) Appl. No.: 14/212,918

(22) Filed: Mar. 14, 2014

Related U.S. Application Data
(60) Provisional application No. 61/787,659, filed on Mar. 15, 2013.

(51) Int. Cl. B29C 67/00

(52) U.S. Cl. CPC B29C 67/0088
USPC 264/497; 425/135

(57) ABSTRACT

One variation of a method for controlling construction of a part over a build platform within a laser sintering device including an opaque door configured to seal the build platform within a build chamber includes: setting a lamp within the build chamber to an off state; detecting electromagnetic radiation within the build chamber based on an output of an optical sensor within the build chamber; in response to detection of electromagnetic radiation above a threshold flux, interrupting construction of the part within the build chamber; in response to detection of electromagnetic radiation below the threshold flux, setting the lamp to an on state to illuminate the build chamber; at an image sensor within the build chamber, capturing a digital image of the laser sintering site; and rendering the digital image on a digital display arranged on an exterior surface of the laser sintering device.

### CROSS-REFERENCE TO RELATED APPLICATIONS

The application claims the benefit of U.S. Provisional Patent Application No. 61/787,659 filed on 15 Mar. 2013, which is incorporated in its entirety by this reference.

### TECHNICAL FIELD

This invention relates generally to laser sintering machines, and more specifically to a new and useful laser sintering apparatus and methods for detecting a temperature at a laser sintering site and detecting light leakage in the field of laser sintering machines.

### BRIEF DESCRIPTION OF THE FIGURES

FIGS. 1A and 1B are schematic representations of an apparatus of one embodiment of the invention;

FIG. 2 is a flowchart representation of a method of one embodiment of the invention; and

FIG. 3 is a flowchart representation of a method of one embodiment of the invention.

### DESCRIPTION OF THE EMBODIMENTS

The following description of the embodiment of the invention is not intended to limit the invention to these embodiments, but rather to enable any person skilled in the art to make and use this invention.

### 1. Apparatus

As shown in FIG. 1, an apparatus 100 for manufacturing includes: a build chamber 120 including a build platform 122; an actuator 124 arranged within the build chamber 120 and over the build platform 122; a laser output optic 130 supported by the actuator 124; an image sensor 140 arranged within the build chamber 120, defining a field of view including a laser sintering site over the build platform 122, and configured to output a digital image corresponding to a first time; and a processor 160 configured to control a shutter speed of the image sensor 140 and to correlate a light intensity of a pixel within the first digital image with a temperature at the laser sintering site at the first time based a shutter speed of the image sensor 140.

As shown in FIG. 1, one variation of the apparatus 100 includes: a build chamber 120 including a build platform 122; an actuator 124 arranged within the build chamber 120; a laser output optic 130 supported by the actuator 124 and configured to communicate an energy beam toward a laser sintering site over the build platform 122; a housing 110 containing the build chamber 120, the actuator 124, and the laser output optic 130 and defining an aperture 114 into the build chamber 120; an opaque door 112 coupled to the housing 110 and configured to close the aperture 114; an image sensor 140 arranged within the housing 110 and directed toward the laser sintering site; and a display 180 arranged on an exterior surface of the opaque door 112 and configured to render images output by the image sensor 140 substantially in real-time.

Generally, the apparatus 100 functions as an additive manufacturing device configured to construct three-dimensional structures within the build chamber by selectively melting regions of deposited layers of powdered material (or “build material”). In particular, the apparatus 100 manipulates a laser output optic 130 relative to a build platform 122 and intermittently outputs a beam of energy toward a topmost layer of material deposited over the build platform 122 to selectively melt areas of the powdered material, thereby “fusing” these areas the powdered material.

The apparatus 100 includes a subsystem to optically measure the temperature of a fuse zone and/or an anneal zone (collectively a “laser sintering site”) in a layer of material supported over the build platform 122 within the build chamber 120. For example, this optical subsystem can function by implementing the first method described below to convert a light intensity of a pixel within a digital image into a temperature at a corresponding location in the build material over the build platform 122. This subsystem can thus enable closed-loop laser power control through non-contact temperature measurement of material at laser sintering sites during additive part construction. This subsystem can also enable over-temperature and under-temperature events during construction of a part within the build chamber. Such functionality can enable higher-quality, higher-yield parts with fewer long-term failures. Detected temperatures at laser sintering sites can also be recorded to support failure mode analysis for failed parts and/or to guide inspection routines for newly-completed parts and/or for parts in use over time. Generally, the laser sintering site defines an interaction zone between an energy beam output from the laser output optic 130 and a layer of powdered material deposited over the build platform 122. As the laser output optic 130 is moved (e.g., scanned, rastered) over the layer of powdered material, the laser sintering site moves with the energy beam projected from the laser output optic 130 onto the topmost layer of powdered material over the build platform.

The apparatus 100 can also include a subsystem to detect leakage of ambient electromagnetic radiation (e.g., light in the visible and/or infrared (IR) spectrums) into the build chamber 120, which may be correlated with leakage of laser light out of the build chamber 120. Therefore, in response to detected levels of light within the build chamber 120 above a threshold (e.g., a threshold light flux), the apparatus 100 can trigger an interlock to prevent initiation of a part build and/or to pause construction of a part within the build chamber, thereby maintaining a suitable degree of eye safety proximal the apparatus 100.

The apparatus 100 can further include a subsystem to collect digital images inside of the build chamber 120 and to display these images on an external display coupled to the apparatus 100—such as during a part build routine—to enable a substantially real-time view of the build chamber while the build chamber is closed and sealed without necessitating a laser safety window between the build chamber 120 and the exterior of the apparatus 100. For example, this subsystem can include an image sensor (e.g., a digital camera) and a digital display rather than a laser safety window to provide a live view into the build chamber 120 without sacrificing (eye) safety of the apparatus 100 during operation of one or more laser diodes within.

### 1.1 Build Chamber and Actuation

The build chamber 120 includes the build platform 122. Generally, the build chamber 120 defines a sealable volume in which a part is additively constructed by selectively fusing areas of subsequent layers of powdered material. The build chamber 120 can therefore include the build platform 122 coupled to a vertical (i.e., Z-axis) actuator configured to vertically step the build platform 122 as additional layers of powdered material are deposited and smoothed over the build platform and then subsequent layers of powdered material. The laser output optic 130 is arranged over the build platform, is coupled to the actuator 124 (e.g., via a computer-numeric control X-Y table 126), and is configured to project an energy beam onto a topmost layer of powdered material as the actuator 124 scans the laser output optics over the build platform, as described below.

In one implementation, the build chamber 120 defines a parallel-sided rectilinear volume, and the build platform 122 rides vertically within the build chamber 120 to form a powder-tight seal against the build chamber 120 walls. In this implementation, the vertical interior walls of the build chamber 120 can be mirror-polished and/or lapped to adjacent faces of the build platform 122 to prevent powdered material from falling passed the build platform 122, thereby substantially preventing horizontal disruption of powdered material across the build platform 122 during deposition of additional material across and vertical actuation of the build platform. Alternatively, the build platform 122 can include a scraper, a spring steel ring, and/or an elastomer seal that seals against a wall of the build chamber to prevent powdered material from falling passed the build platform 122. Yet alternatively, the build platform 122 can be sealed against the walls of the build chamber 120 with a bellows or other expandable seal. The build platform 122 and vertical walls of the build chamber 120 can also be of substantially similar materials—such as 304 stainless steel—to maintain substantially consistent gaps between mating surfaces or seals of the build chamber 120 and the build platform 122 throughout various operating temperatures within the build chamber. However, the build chamber 120 and the build platform 122 can be any other material (e.g., aluminum, alumina, glass, etc.) or shape (e.g., cylindrical) and can mate in any other suitable way.

The actuator 124 is arranged within the build chamber 120 and over the build platform 122. Generally, the actuator 124 functions to support the laser output optic 130 and to maneuver the laser output optic 130 across a plane parallel to and over the build platform 122. In particular, as the actuator 124 moves to various positions over the build chamber 120, a laser diode within the apparatus 100 intermittently generates an energy beam that is communicated toward a topmost layer of powdered material on the build platform 122 by a corresponding laser output optic to selectively heat, fuse, and/or anneal particular area of the layer of powdered material, such as specified in a part build file.

In one implementation, the actuator 124 includes a first actuator and a second actuator that cooperate to scan the laser output optic over the build platform. For example, each of the first and second actuators can include a lead screw, a ball screw, a rack and pinion, a pulley, or other power transmission system driven by a servo, stepper motor, or other electromechanical, pneumatic, or other actuator. In one example implementation, the first actuator includes a pair of electromechanical rotary motors configured to drive parallel lead screws supporting each side of the second actuator, which includes a single stepper motor configured to drive the gantry with the along a second rail system over the build platform.

Furthermore, with the laser output optic(s) (non-transiently) focused to a particular vertical depth over the build platform, the Z-axis actuator supporting the build platform can maintain each subsequent topmost layer of powdered material at a particular corresponding vertical distance from the laser output optic(s). In particular, the Z-axis actuator and/or the build chamber 120 can constrain the build platform in three degrees of rotation and in two degrees of translation (i.e., along the X- and Y-axis). Like the X- and Y-axis components (e.g., the first and second actuators) of the actuator 124 described above, the Z-axis actuator can include a lead screw, ball screw, rack and pinion, pulley, or other suitable mechanism powered by a servo, stepper motor, or other suitable type of actuator. The Z-axis actuator can also include a multi-rail and/or multi-drive system that maintains the build platform 122 in a position substantially normal to the laser output optic throughout various vertical positions within the build chamber during operation. For example, the Z-axis actuator can include a leveling system to step the build platform 122 along parallel vertical positions within the build chamber 120.

In one implementation, the actuator 124 enables a position resolution of 50 um to 100 um with an approximate step size 5 um-25 um, and the Z-axis actuator positions the build platform within the build chamber at a resolution of 20 um-100 μm with an approximate step size of 2 μm-5 μm. In this implementation, the laser output optic 130 can also cooperate with the laser diode to achieve a default material fuse diameter of 100 μm and a material fuse diameter range of 50 μm to 1000 μm.

The Z-axis actuator can further leverage weight of layers of powdered material deposited over the build platform 122 to stabilize vertical location of the build platform 122 within the build chamber during a part build routine.

The housing 110 contains the build chamber 120, the actuator 124, and the laser output optic 130 and defines the aperture 114 into the build chamber 120. Generally, the housing 110 defines an external structure that contains various components of the apparatus 100, such as the build chamber 120, the actuator 124, the laser, and the laser output optic 130, and defines a safety volume for containment of laser light output by the laser diode (e.g., output through the laser output optic 130).

In one implementation, the housing 110 includes a tubular steel skeleton with exterior panels of laser-reflective or laser-absorptive material (e.g., copper, stainless steel, copper-plated aluminum) suspended from the skeleton with tamperproof fasteners. In this implementation, the build chamber 120 can be supported fully within the steel skeleton such that laser light that escapes from the build chamber 120 is contained within the housing 110. In this implementation, the housing 110 can further support the opaque door 112, which is configured to close an aperture within the housing 110 and the build chamber 120. In particular, the aperture 114 can provide manual access into the build chamber 120, such as to enable removal of a completed part from the build chamber 120 by a user, to provide access to the build chamber 120 for cleaning (e.g., removal of remnants of a previous powdered material), and/or to enable insertion and removal of a material cartridge (described below) into the apparatus. For example, the opaque door 112 can include an external skin similar to the exterior panels of the housing 110, and the opaque door 112 can include an interior panel or surface similar to interior panels or surfaces of the build chamber 120 and seal against a face of the build platform 122. Thus, in a closed position, the opaque door 112 can obstruct transmission of laser light out of the build chamber 120 via the aperture 114, and, in an open position, the opaque door 112 can enable physical access into the build chamber 120 via the aperture 114.

The opaque door 112 and the housing 110 can also include a locking mechanism to lock the opaque door 112 in the closed position immediately prior to and/or during a build routine for a part within the build chamber 120. The opaque door 112 can also include laser-absorptive or laser-reflective seal—such as a black polymer (e.g., neoprene) shield—around its perimeter to seal the opaque door 112 against a surface of the housing 110 and/or against a surface of the build chamber 120 around the aperture 114 in the closed position. However, the housing 110 and the door can function in any other way to contain elements of the apparatus 100 and to seal the interior volume of the housing 110 and/or the build chamber 120 from release of laser light from the apparatus 100.

### 1.2 Material Handling

One variation of the apparatus 100 further includes a powder system supporting supply of powdered materials into the apparatus 100 and distribution of powdered material within the build chamber 120.

In one implementation, the powder system includes a material cartridge defining a storage container for a particular type or combination of types of powdered materials for use within the apparatus 100 to build a three-dimensional part. The material cartridge can be initially sealed (e.g., airtight) to maintain an internal atmosphere, thereby extending a shelf life of fresh powdered material within by preventing oxidation of the powdered material through contact with air. The material cartridge can also be resealable. For example, after being loaded into the apparatus 100, the cartridge 190 can be opened, powdered material removed from the cartridge 190, an inert atmosphere reinstated within the cartridge 190, and the cartridge 190 resealed once a part build is complete to prolong life of material remaining in the cartridge 190.

The cartridge 190 can also include one or more sensors configured to output signals corresponding to a level of material within the cartridge 190, an atmosphere type within the cartridge 190, and/or an atmosphere quality within the cartridge 190, etc. For example, the material cartridge can include a resistance sensor, a capacitive sensor, an inductive sensor, a piezoelectric sensor, and/or a weight sensor configured to detect material volume, material type, and atmosphere within the cartridge. The cartridge 190 can also include additional sensors configured to detect (basic) material properties, such as density, fuse or melting temperature, emissivity, etc. and/or to verify that a material loaded into the cartridge 190 matches a material code stored on or within the cartridge 190. The cartridge 190 can further include temperature, humidity, and/or gas sensors to monitor life and quality of material stored within the cartridge over time, such as on a regular (e.g., hourly) basis, continually, or when requested automatically by the apparatus 100 or manually by an operator.

The cartridge 190 can further include a wireless transmitter configured to transmit corresponding cartridge data, such as material level, atmosphere type and quality, contained material type, material properties of a contained material, material age, material source or destination, build or apparatus installation history, lot number, manufacturing date, etc. The cartridge 190 can store any of the foregoing data locally and transmit these data to the apparatus 100 before or during a part build to support part construction. Alternatively, the cartridge 190 can transmit a unique identifier to the apparatus 100, and the apparatus 100 can interface with a database, remote server, or computer network to retrieve relevant material and/or cartridge data assigned to or associated with the unique identifier. For example, each cartridge within a set of cartridges containing powdered materials for part construction can be assigned a unique identifier to track the cartridges through a logistics supply chain, to verify material authenticity, to monitor cartridges usage rates, etc. Additionally or alternatively, the material cartridge can communicate with the apparatus 100 over an electrical (i.e., wired) interface when loaded into the apparatus 100. The electrical interface can thus support communication of data between the apparatus 100 (e.g., the processor 160) and the material cartridge.

Furthermore, the material cartridge can include a processor 160 configured to monitor sensor outputs, to correlate sensor outputs with relevant data types (e.g., material temperature, internal material volume), to trigger alarms or flags for material mishandling, to handle communications to and/or from the apparatus 100, etc.

In one implementation, the material cartridge includes memory or a data storage module 170 that stores material-related data and/or data uploaded onto the cartridge 190 by the apparatus 100 before, during, and/or after part construction with material sourced from the cartridge 190. Data transmitted to and/or from the cartridge 190 can also be encoded, encrypted, and/or authenticated to enable verification or authorization of use of the cartridge 190, to identify a compromised material cartridge, to secure a corresponding material supply chain, to detect material counterfeiting activities, etc.

The material cartridge includes an (resealable) output, and the apparatus 100 can extract material from this output for dispensation into the build chamber 120. For example, material can be extracted from the cartridge 190 mechanically, such as with a lift, gravity feed, a rotational screw lift or screw drive, a conveyor, a drag chain, etc. Material can alternatively be removed from the cartridge 190 pneumatically or in any other suitable way.

In this variation, the powder system further includes a powder distribution and leveling system within the apparatus 100. Generally, for each additional build layer of the part during construction, the powder distribution and leveling system meters a particular volume, mass, and/or weight, etc. of material from the cartridge 190 and distributes this amount of material evenly over the build chamber 120 (or over a preceding layer of material) to yield a flat, level, consistent build surface at a consistent and repeatable distance from the laser output optic 130. In particular, once the volume of material is delivered to the build platform 122, the leveling system (e.g., a recoder blade) moves across the build chamber 120 to distribute the powder evenly across the build platform. The leveling system can include multiple replaceable blades, a fixed permanent leveling blade, a vibration system, or any other suitable leveling system. The leveling system can further implement closed-loop feedback based on a position of a blade and/or a power consumption of a corresponding actuator during a material leveling cycle to prevent disruption of previous layers of material and/or to prevent damage to previously-fused regions of prior material layers.

The powder distribution and leveling system can also recycle remaining material from the build chamber 120 once the build cycle is complete. For example, once the build cycle is complete, the powder distribution and leveling system can collect un-melted powder from the build chamber, pass this remaining powder through a filtration system, and return the remaining filtered material back into the material cartridge. In this example, the powder distribution and leveling system can include a vacuum that sucks remaining powdered material off of the build platform 122, passes this material over a weight-based catch system (or filler), and drops the filtered material into an inlet at the top of the cartridge 190. Furthermore, as this remaining material is filtered, powders that fall outside of a particle size requirement or particular size range can be removed a return supply to the cartridge 190.

Alternatively, once the build cycle is complete, the powder distribution and leveling system can drain unused powder from the build chamber 120 via gravity, filter the powder, and return the filtered powder to the powder cartridge via a mechanical lift system. For example, the build chamber can define drainage ports proximal its bottom (e.g., opposite the laser output optics and/or the lens) such that, to drain remaining un-melted material from the build chamber, the build platform is lowered passed a threshold vertical position to expose the drainage ports 128 to the material. The material can thus flow out of these ports 128 via gravity and can then be collected, filtered, and returned to the cartridge 190, as shown in FIG. 1. Furthermore, in this example, a blower arranged over the build platform 122 or a vacuum coupled to the drainage ports 128 can draw any remaining material through the drainage ports 128 and/or decrease drainage time. Additionally or alternatively, the powder distribution and leveling system can implement a screw, conveyor, lift, ram, plunger, and/or gas-, vibratory, or gravity-assisted transportation system to return recycled powdered material to the cartridge 190.

In this variation of the apparatus 100, the powder system can therefore define a closed powder system that substantially reduces or eliminates human (e.g., operator) interaction with raw powdered materials for part construction within the apparatus 100. This closed powder system can include multiple powder material cartridges, powder filters, powder recycling systems, powder distribution and leveling systems, etc. The apparatus 100 can also hold multiple material cartridges simultaneously to enable use of combinations of materials within a single part, such as on a per-layer basis.

### 1.3 Optics

The laser output optic 130 is supported by the actuator 124 and is configured to communicate an energy beam from a laser diode toward a layer of powdered material dispensed onto the build platform 122. Generally, the laser output optic 130 (or laser head) can be manipulated across a plane parallel to the build surface of the build platform 122 to intermittently direct a beam of energy toward a laser sintering site to selectively fuse regions of the layer of powdered material. The laser output optic 130 can also direct an intermittent beam of energy toward the laser sintering site to anneal fused regions of metal powder. The apparatus 100 can additionally or alternatively include a second laser output optic supported by the actuator 124 and similarly configured to output an energy beam toward the build platform to anneal fused areas of the powdered material.

The apparatus 100 can therefore include a laser system, including the laser output optic(s). Components within the laser system can cooperate to melt (or “fuse”) powdered material, to anneal and/or stress relieve melted material, to optically inspect areas of melted material, etc. In one implementation, the laser system includes a laser diode coupled to the laser output optic 130 via a single-core fiber optic cable 134. In this implementation, the laser diode 132 can be mounted in a fixed position within the housing 110, and the fiber optic cable 134 can accommodate changes in distance between the laser diode 132 and the laser output optic 130 as the actuator 124 displaces the laser output optic 130 laterally (i.e., parallel to the build surface) to selectively melt areas of the topmost layer of powdered material on the build platform 122.

In a similar implementation, the laser system includes a set of laser diodes coupled to the laser output optic 130 with a multi-cored fiber optic cable 134. Thus, in this implementation, energy beams from the set of laser diodes can be routed to the laser output optic 130 through a singular cable. For example, multiple substantially identical laser diodes can be arranged within the apparatus 100, their outputs grouped with a multi-cored fiber optic cable 134, and their outputs combined at the laser output optic 130 to yield a higher-power and/or higher-energy density energy beam than that generated by a single laser diode. In this example, the laser diodes can be maintained in phase to yield predominately constructive interference at the laser sintering site, or the set of laser diodes can be shifted out of phase to modify a size, shape, power density, or other property of the composite energy beam output from the laser output optic 130. Similarly, the set of laser diodes can include multiple laser diodes operating at different wavelengths such that a range of focal lengths and focal areas at the laser sintering site (i.e., at the build surface) can be achieved by modulating power output from the various laser diodes in the set. In particular, by adjusting energy density ratios (or power) output of select laser diodes in the set to control constructive and destructive interference between the corresponding energy beams output from the laser output optic 130, the apparatus 100 can manipulate melt pool sizes, melt pool depth, material temperature within the melt pool, etc. at a current laser sintering site. In this implementation, by balancing power and energy output from each laser diode in the set, properties of the melt pool and annealing zones can thus be controlled. For example, circular zones of energy densities can yield more gradual cooling within a melt pool or anneal zone across a greater portion of a laser impact zone than a tightly-focused energy beam, and the apparatus 100 can control energy beam sizes according to a desired heating effect at the laser sintering site.

Additionally or alternatively, the laser output optic 130 can include an adjustable focusing system configured to automatically or through manual adjustment modify a focal length and/or focal area of an energy beam directed toward the laser sintering site. The adjustable focusing system can also accommodate temperature, pressure, and/or atmospheric changes within the build chamber 120, flexure of the housing 110 or build chamber (e.g., due to physical impact), etc. For example, the adjustable focusing system can adjust a position of a lens or a mirror to adjust a size of the laser spot on the topmost surface of deposited powdered material size.

In the implementation described above that includes multiple laser diodes outputting energy beams into the laser output optic 130, the laser output optic 130 can further include a set of focusing systems, each focusing system corresponding to one discrete laser diode. The laser output optic 130 can direct each energy beam from the set of laser diodes toward a singular point at a fixed distance from the laser output optic 130, and the set of focusing systems can manipulate the focal length and/or focal area of corresponding energy beams and thus achieve a controlled energy density over a controlled area at the fixed distance. The laser system can manipulate the set of adjustable focusing systems independently, simultaneously, or in combination.

The laser system can incorporate holographic optics, small, high-speed imagers, rapid adjustment focusing systems (e.g., a voice coil motor), focus reference systems with optical over and under focus detection, etc. to support optical feedback techniques to maintain constant or dynamic target energy beam focusing during part construction. The laser system can additionally or alternatively manipulate voltage, current, rise time, fall time, pulse time, laser pulse profile, power, duration, wavelength, etc. of one or more laser diodes within the laser system. The laser system can also incorporate power control, power factor, and/or power stabilization capabilities.

### 1.3 Temperature Sensing

The image sensor 140 is arranged within the build chamber 120, defines a field of view including the laser sintering site, and is configured to output a digital image corresponding to a first time. Generally, the image sensor 140 is arranged within the build chamber 120 and is configured to output an image of the laser sintering site such that a processor 160 within the apparatus 100 can correlate an intensity (e.g., brightness) of a pixel within the image with a temperature at the laser sintering site. For example, the image sensor 140 can cooperate with the processor 160 to implement first method S100 described below.

The image sensor 140 can be coupled to the actuator 124 proximal the laser output optic 130 such that the image sensor 140 moves with the laser output optic 130 across the plane of the build platform 122. In particular, an offset between the image sensor 140 and the laser output optic 130 can be fixed such that the energy beam output from the laser output optic 130 remains in substantially the same position within the field of view of the image sensor 140 for all laser sintering sites across layers of the powdered material. In this configuration, the focus of the image sensor 140 can be static (i.e., fixed) for the preset distance between the image sensor 140 and the laser output optic 130.

Thus, distance between the image sensor 140 can be substantially static and known for all laser sintering sites across all layers of powdered material dispensed during a build cycle. Alternatively, a first distance between the image sensor 140 can be set and implemented for all fuse sites (i.e., areas of a topmost layer of powdered material that are melted) during a build cycle, and a second distance between the image sensor 140 can be set and implemented for all anneal sites (i.e., areas of a topmost layer of powdered material that are anneal) during a build cycle. In this configuration, the processor 160 (described below) can store these fixed distances between the image sensor 140 and the laser sintering site and apply these distances to conversion of light intensity at a pixel in an image sensor output into a temperature at a corresponding region of the laser sintering site, such as based on current irradiation type (i.e., fuse or anneal) in the build cycle.

Alternatively, the image sensor 140 can be coupled to the build chamber 120 or to the build platform 122. A focusing system coupled to the image sensor 140 can then rotate and/or translate the image sensor 140 to maintain a current laser sintering site within the field of view of the image sensor 140, such as based on a current X and/or Y position of the actuator 124 (and therefore a position of the laser output optic 130 and a current laser sintering site) and/or based on a current Z position of the build platform 122. The focusing system can additionally or alternatively adjust a focusing element of the image sensor 140 to enable in-focus capture of an image of the laser sintering site, such as based on an X, Y, and/or Z position of the actuator 124 and/or the build platform 122. In this configuration, the processor 160 can also implement the X, Y, and/or Z positions of the laser sintering site (based on corresponding positions of the actuator(s)) to calculate a distance between the image sensor 140 and a laser sintering site for a particular image sensor output, and the processor 160 can then apply this distance to conversion of light intensity at a pixel in the corresponding image into a temperature at a corresponding region of the laser sintering site. However, the focusing system can function in any other way to maintain a current laser sintering site within the field of view of the image sensor 140 and in focus.

In one implementation, the image sensor 140 includes a charge-coupled device (CCD) camera. Alternatively, the image sensor 140 can include an active pixel sensor (CMOS) camera. For example, the image sensor 140 can include a CCD camera with a microscope lens directed toward the laser sintering site. The apparatus 100 can also include a near-infrared filter and/or a heat shield arranged between the image sensor 140 and the laser sintering site, such as over a lens of the image sensor 140. In particular, the near-infrared filter can predominantly filter all but a narrow range of electromagnetic radiation within the infrared spectrum corresponding to light emission from the heated build material such that the image sensor 140 is relatively more sensitive to infrared light—and therefore thermal radiation—and relatively less sensitive to visible light and electromagnetic radiation in other spectrums. For example, the near-infrared filter can predominantly filter (i.e., block transmission of) a narrow of electromagnetic radiation including the wavelength(s) of laser light output from the laser diode 132. The image sensor 140 can thus output a digital photographic image in the infrared spectrum of the laser sintering site, and the processor 160 can transform the intensity of incident light on captured in pixels of the digital photographic image into temperatures of corresponding regions in and around the laser sintering site.

The image sensor 140 can also feature an adjustable shutter speed, exposure time, ISO speed, aperture, integration time, and/or sampling rate such that an imaging parameter of the image sensor 140 can be matched to (i.e., set based on) a predicted or anticipated material temperature at the laser sintering site. With image sensor shutter speed (and/or other imaging parameter) thus set, pixels in the digital image can record infrared light intensities between a minimum and a maximum pixel light intensity, thereby enabling substantially accurate correlation of recorded pixel light intensity to temperature at a corresponding region of the laser sintering site.

The processor 160 of the apparatus 100 is therefore coupled to the image sensor 140 and is configured to control a shutter speed of the image sensor 140. The processor 160 can further receive digital images from the image sensor 140 and to correlate a light intensity of a pixel within the digital image with a temperature at the laser sintering site at a corresponding time based a shutter speed of the image sensor 140. Generally, the processor 160 functions to implement the first method described below to convert light intensity captured at one or a set of pixels within the digital image into a temperature at a laser sintering site corresponding to the image (i.e., the laser sintering site at the time the image was taken). For example, the processor 160 can interface with a material cartridge loaded into the apparatus 100 to identify a type of material dispensed into the build chamber 120. In this example, the processor 160 can then identify an emissivity of the material based on an emissivity lookup table stored locally (e.g., on a data storage module 170 described below) or by retrieving the emissivity of the material from a remote database. The processor 160 can then implement this emissivity of the material, a fixed (known) or calculated distance between the image sensor 140 and the laser sintering site, the shutter speed of the image sensor 140, and/or the sample rate of the image sensor 140, etc. to convert light intensity of one or more pixels in an image with one or more temperatures at the laser sintering site. For example, the processor 160 can pass the emissivity, the distance between the image sensor 140 and the laser sintering site, and the shutter speed of the image sensor 140 into an algorithm that outputs a matrix of temperatures for corresponding regions of the laser sintering site by X and Y positions.

As described below, the processor 160 can further extrapolate temperatures from a series of images corresponding to various laser sintering sites within the build chamber 120 to track material temperatures temperature at fuse sites throughout a part build. For example, as shown in FIG. 1, one variation of the apparatus 100 includes a data storage module 170 configured to store the digital image, the first temperature, and a timestamp corresponding to a build time of a part on the build platform 122 relative to the first time. The processor 160 can thus generate part build datasets including temperatures, times, and corresponding locations or positions within the part and store these datasets locally on the apparatus 100. These datasets can later be accessed to provide insight into construction, specification achievement, inspection, failure, etc. for the specific corresponding part.

As described below, the processor 160 can also interface with the laser system to regulate power output of the laser diode 132 based on a detected temperature at the laser sintering site. For example, if the detected temperature of a particular region of a previous laser sintering site is below a target temperature, the processor 160 can increase the power output of the laser diode 132 accordingly. Similarly, if the detected temperature of a particular region of a previous laser sintering site is above a target temperature, the processor 160 can decrease the power output of the laser diode 132 accordingly. The processor 160 can also trigger alarms or store flags in the memory module for detected laser sintering site temperatures that differ from the target temperature by more than a threshold temperature (e.g., by more than 40° C.).

As described below, the processor 160 can also set a second shutter speed for the image sensor 140 to capture a digital photographic image of the laser sintering sight in the visible spectrum. For example, the processor 160 can set the image sensor 140 to a first shutter speed of 15 milliseconds to capture an image of the laser sintering site supporting detection of laser sintering site temperatures between 480° C. and 560° C., and the processor 160 can then set a second shutter speed of the image sensor 140 to 273 milliseconds to capture enough light in the build chamber 120 to show loose powder and fused regions on the top layer of powdered material. In the variation of the apparatus 100 that includes a display on an exterior surface of the housing 110, the display 180 can further render this image, such as to enable an operator outside of the build chamber to visually ascertain a status of part construction within the build chamber 120. Additionally or alternatively, the processor 160 can store the image on the data storage module for later access, such as by an operator, an inspector, etc.

However, the processor 160 and the image sensor 140 can cooperate in any other way to detect and handle temperatures at the laser sintering site during construction of a part within the apparatus 100.

### 1.4 Light Leakage Interlock

As shown in FIG. 1, one variation of the apparatus 100 includes an optical sensor 150 configured to detect electromagnetic radiation within the build chamber 120 in response to closure of the opaque door 112. In this variation, the apparatus 100 can also include a lamp configured to illuminate the build chamber 120 in an on state—such as during image capture of the laser sintering site by the image sensor 140 as described above—and to transition to an off state during detection of electromagnetic radiation by the optical sensor 150. Generally, once the opaque door 112 is closed and before part construction commences, the lamp 152 can be set to an off state such that any detected electromagnet radiation within the build chamber 120 may correlate to light leakage into the apparatus 100 from outside the housing 110. Light leakage into the apparatus 100 may also suggest that laser light output from the laser diode 132 via the laser output optic 130 may also escape outside of the apparatus 100. Thus, when the optical sensor 150 outputs a signal corresponding to presence of electromagnetic radiation within the build chamber 120, the processor 160 can trip an interlock or trigger an alarm to stop part construction to reduce or substantially eliminate possibility of leakage of laser light from the apparatus 100.

The optical sensor 150 can be configured to detect visible and/or infrared light (or electromagnetic radiation in any other spectrum) and can output a signal accordingly. For example, the optical sensor 150 can include a photodetector, such as a photovoltaic cell, a photodiode, a photomultiplier tube, a phototube, a photodarlington, or a phototransistor. The optical sensor 150 can also be arranged within the build chamber 120, such as on a wall of the build chamber 120 opposite the door. Alternatively, the optical sensor 150 can be coupled to an interior surface of the opaque door 112 or elsewhere within the housing 110. The apparatus 100 can also include multiple optical sensors, and the processor 160 can analyze outputs of each optical sensor to detect light leakage into (and therefore potential laser light leakage out of) the housing 110. The processor 160 can also compare signals from the optical sensors to identify a region of the apparatus 100 exhibiting greatest light leakage. For example, the apparatus 100 can include such optical sensors on the opaque door 112 proximal its top, bottom, and sides edges, in the build chamber 120 on each (vertical) side of the build platform 122, in each interior corner of the housing 110, and along a path of a fiber optic cable 134 that communicates a beam of energy from the laser diode 132 to the laser output optic 130. In this example, the processor 160 can thus identify regions of the apparatus 100 exhibiting greatest light leakage. The apparatus 100 can further provide these data to operators to support repair of portions of the apparatus 100 exhibiting light leakage.

In one example, the processor 160 trips the interlock if detected electromagnetic radiation within the apparatus 100 exceeds a threshold flux. In this example, the threshold flux can accommodate drift or noise in the optical sensor 150 to prevent false positive detection of electromagnetic radiation correlated with light leakage. Furthermore, for the apparatus 100 that includes multiple optical sensors, the processor 160 can analyze each sensor output independently for light flux that exceeds the threshold flux, or the processor 160 can aggregate the outputs of the optical sensors and compare this composite light flux to the threshold light flux. Thus, if more than a threshold level of electromagnetic radiation is sensed within the apparatus 100, the processor 160 can stop or postpone construction of the part. The processor 160 can also trigger an audible alarm or any other suitable alarm, interrupt, or interlock in response to detection of electromagnetic radiation above the threshold flux.

However, if electromagnetic radiation less than the threshold flux is detected, the processor 160 can transition into a part build routine to initiate construction of the part. For example, the processor 160 can set the lamp 152 to an ON state to light the build chamber 120 such that an image sensor or camera within the build chamber 120 can capture digital images of the laser sintering sites and such that a digital display on an exterior surface of the housing 110 can render these images substantially in real-time, thereby providing a digital window into the build chamber 120 substantially in real-time.

In this variation, the apparatus 100 can also include a filter that permits a single electromagnetic frequency, a select set of electromagnetic frequencies, or a limited range of electromagnetic frequencies to pass from the lamp 152 into the build chamber 120, and the process 160 can analyze an output of the optical sensor 150—ignoring the single electromagnetic frequency or a limited range of electromagnetic frequencies passing out of the lamp 152—to detect light leakage into the housing 110. In particular, in this implementation, the lamp 152 can remain on during detection of light leakage into the housing as the processor ignores electromagnetic frequencies passed by the filter. For example, the filter can permit only green light to pass from the lamp 152 into the build chamber, and the processor can analyze only red light and blue light incident on the optical sensor 150 to detect light leakage into the apparatus 100 even when the lamp 152 is in the ON state. Similarly, the apparatus 100 can include a second filter arranged over the optical sensor 150, wherein the second filter passes substantially all electromagnetic radiation except frequencies passed by the filter over the lamp. For example, the filter can permit only green light to pass from the lamp 152 into the build chamber, and the second filter can permit only red light and blue light to pass from the build chamber 120 into the optical sensor 150 such that light incident on the optical sensor 150 can be correlated with light leakage into the housing 110 even when the lamp 152 remains in the ON state during a light leakage test.

The processor 160, the lamp 152, and the one or more optical sensors can therefore implement the second method described below to determine that the apparatus 100 is sealed from emission of laser light outside of the housing 110 prior to beginning a build cycle for a part.

The processor 160 can also intermittently interrupt construction of a part to test for light leakage into the apparatus 100, as described above, and pause part construction if light leakage is detected, as described below. For example, after each new layer of powdered material is deposited onto and leveled across a previous layer over the build platform 122, the processor 160 can set the lamp 152 to an off state and collect outputs from the optical sensors once a previous laser sintering site has cooled to below a threshold temperature. If electromagnetic radiation is detected above the threshold flux, the processor 160 can thus pause further construction of the part and/or trigger an alarm, etc. However, if electromagnetic radiation less than the threshold flux is detected, the processor 160 can return to the part build routine to complete construction of the part.

As shown in FIG. 1, one variation of the apparatus 100 further includes a second lamp 152 arranged on an exterior surface of the housing 110 and is configured to emit light toward the aperture 114 (e.g., around the perimeter of the opaque door 112). The second lamp 152 can thus provide a constant light source around the door to support detection of light leakage passed the opaque door 112 regardless of ambient light conditions around the apparatus 100. The processor 160 can thus cooperate with the optical sensor 150 to detect leakage of light from the second lamp 152 into the build chamber 120. The apparatus 100 can also include similar lamps on other external surfaces of the housing 110, and the processor 160 can cooperate with corresponding optical sensors to detect light leakage into the apparatus 100 from any of these light sources.

However, the processor 160, the lamp(s), and the optical sensor(s) can cooperate in any other way to detect light leakage into the apparatus 100, to correlate this light leakage with an unsealed apparatus, and to postpone or interrupt construction of a part within the build chamber 120 accordingly.

### 1.5 Digital Window

In the variation of the apparatus 100 described above that includes a lamp configured to illuminate the build chamber 120, the apparatus 100 can also include a display arranged on an exterior surface of the apparatus 100 and configured to render images output by one or more image sensors substantially in real-time. For example, the display 180 can be arranged on an exterior surface of the opaque door 112, and the apparatus 100 can include a second image sensor 142 directed from proximal the center of the interior of the door toward the build chamber 120. The second image sensor 142 can output a video feed (e.g., a stream of four digital images per second), and the display 180 can render the video feed substantially in real-time, thereby mimicking a transparent or translucent window on the opaque door 112. Thus, the combination of the display 180 and the second image sensor 142 can eliminate a need for a laser safety window while still providing a live view into the build chamber 120 without substantial eye safety risk from stray laser light escaping the apparatus 100.

The display 180 can also render images or video feeds from other image sensors (e.g., cameras) arranged within the build chamber 120 and/or within other areas of the apparatus 100. For example, the display 180 can cycle through video feeds from image sensors arranged at various positions around the build chamber 120 (e.g., at each upper corner of the build chamber 120). The display 180 can also render a photographic image output by the image sensor 140 supported from the actuator 124 proximal the laser output optic 130. Alternatively, display can render only images output by the second image sensor 142 directed from proximal the center of the opaque door 112 toward the build chamber 120, and the apparatus 100 can include a second display that renders (or cycles through) images output by other image sensors within the apparatus 100.

In various examples, the display 180 can include any suitable type of display, such as an light-emitting diode (LED) display, a cathode ray tube (CRT) display, a liquid crystal display (LCD), a capacitive touch display (e.g., a digital display with a capacitive touch sensor), etc. However, the display 180 can include any other suitable type of display (and/or touch sensor).

As described above, the apparatus 100 can also store any one or more of these images and/or video feeds. For example, the apparatus 100 can store all or a compressed subset of these images locally on the data storage module 170 and with reference to a particular part type and/or serial number, etc. In this example, once the part is complete, the apparatus 100 can further upload these images to a remote database, such as a remote server for later reference (e.g., during part inspection or failure analysis). The apparatus 100 can store and/or upload any of these images automatically, or the apparatus 100 can store and/or upload these images based on a manual input. For example, the apparatus 100 can store an image in response to a manual image capture input entered into a control panel on the apparatus 100 by an operator.

### 2. First Method

As shown in FIG. 2, a method for detecting a temperature at a laser sintering site within a field of view of an image sensor within a laser sintering device can include: based on a selected fuse temperature for a laser sintering build material, setting a first shutter speed for the image sensor 140 in Block S112, the first shutter speed corresponding to a detectable range of temperatures including an anticipated temperature at the laser sintering site; at a first time, capturing a first digital image of the laser sintering site with the image sensor 140 at a first shutter speed in Block S120; and correlating a light intensity of a pixel within the first digital image with a first temperature at the laser sintering site at the first time based on the first shutter speed in Block S130.

As shown in FIG. 2, one variation of the first method S100 can include: retrieving data from a material supply cartridge coupled to a laser sintering device and, based on the data, selecting an emissivity of a material within the material supply cartridge in Block S110; at a first time, capturing a first digital image of the laser sintering site with the image sensor 140 at a first shutter speed in Block S120; and correlating a light intensity of a pixel within the first digital image with a first temperature at the laser sintering site at the first time based on the emissivity of the material and the first shutter speed in Block S130.

Generally, the first method S100 can be implemented by the image sensor 140 and the processor 160 (etc.) of the apparatus 100 to remotely (i.e., without contact) measure a temperature of deposited powdered material at the laser fuse site. The first method S100 functions to convert a light intensity—recorded in one or more pixels of a digital image output by the image sensor 140 proximal the laser sintering site—into a temperature at one or more regions of the laser sintering site at one moment in time. For example, the first method S100 can implement a static, measured, or known emissivity of the powdered material, a distance between the laser sintering site and the image sensor 140, and/or the specified shutter speed of the image sensor 140 to convert light intensity into temperature at the laser sintering site.

### 2.1 Material Data

As shown in FIG. 2, one variation of the first method S100 includes Block S110, which recites retrieving data from a material supply cartridge 190 containing the laser sintering build material and loaded into the laser sintering device and selecting an emissivity of the laser sintering build material based on the data. Block S110 can similarly recite retrieving data from a material supply cartridge 190 coupled to a laser sintering device and, based on the data, selecting an emissivity of a material within the material supply cartridge 190.

Generally, Block S110 interfaces with a material cartridge, as described above, to retrieve relevant information to support image capture and conversion into one or more temperatures at the laser sintering site. For example, Block S110 can download data from a radio frequency identification (RFID) tag arranged on the material cartridge or received from another wireless transmitter on or within the material cartridge. In another example, Block S110 can interface with a camera, scanner, or other optical detector to read a barcode, a quick response (QR) code, alphanumeric text, or other data printed on or applied to an exterior surface of the cartridge 190. Yet alternatively, the cartridge 190 can engage a plug or receptacle within the apparatus 100, and Block S110 can download cartridge- and/or material-related data directly from a memory module within the cartridge 190 via the plug or receptacle.

In one implementation, Block S110 downloads material properties directly from the material cartridge, such as emissivity, fuse temperature or fuse temperature range (i.e., to bond material powders), melting temperature, density, reflectivity, and/or thermal conductivity, etc. of the powered material contained within the cartridge 190. For example, any of these data can be encoded on a wireless transmitter (e.g., RFID tag) or other “chip” arranged on or within the material supply cartridge 190, and Block S110 can download these data when the cartridge 190 is installed into the apparatus 100 or after a part build cycle is started and before material is deposited from the cartridge 190 onto the build platform 122. In another implementation, Block S110 retrieves a material cartridge identifier from the canister, passes the identifier to an external database (e.g., a remote server or computer network), and downloads material property data corresponding to the cartridge 190 from the database, such as over a wired or wireless Internet or Ethernet connection. For example, Block S110 can implement machine vision techniques to read a cartridge serial number printed on a side of the cartridge 190, wirelessly transmit this serial number to a remote database, and download type, age, environment, emissivity, and fuse temperature range for the material within the cartridge 190 from the remote database. In yet another implementation, Block S110 can download an identification number from the material, and Block S110 can select material properties for material within the cartridge 190 based on a material identifier encoded into the identification number. For example, the last three digits on a ten-digit cartridge identification number can be associated with material type in the cartridge 190, and Block S110 can identify the cartridge material as powdered 304 stainless steel and select the corresponding material properties for a cartridge identification number of XX-XXX-X873, and Block S110 can further identify the cartridge material as powdered oxygen-free electrolytic copper and select the corresponding material properties for a cartridge identification number of XX-XXX-X149. Yet alternatively, Block S110 can download data from sensors integrated into the cartridge 190 to retrieve material-related data measured directly from the cartridge 190.

Yet alternatively, Block S110 can retrieve any of the foregoing data from a part build file loaded into and/or stored on the apparatus 100. However, Block 110 can function in any other way to retrieve or select an emissivity, fuse temperature, or other material property or other information based on data collected from the cartridge 190.

### 2.2 Shutter Speed

Block S112 of the first method S100 recites, based on a selected fuse temperature for a laser sintering build material, setting a first shutter speed for the image sensor 140, the first shutter speed corresponding to a detectable range of temperatures including an anticipated temperature at the laser sintering site. Generally, Block S112 functions to set a shutter speed (and/or exposure time, ISO speed, aperture, and/or sampling rate) of the image sensor 140 (e.g., a CCD or CMOS imager) such that (infrared) light incident across pixels of the image sensor 140 during a single shutter cycle fall within a minimum and a maximum light intensity—which correspond to a minimum and maximum detectable temperature for that shutter speed—thereby enabling conversion of recorded pixel light intensity into a temperature at a corresponding region of the laser sintering site.

As described above, the apparatus 100 functions to build a three-dimensional part by selectively fusing regions of subsequent layers of powdered material. To fuse layers of powdered material, the apparatus 100 directs a beam (e.g., a laser beam) of sufficient power to at least superficially melt powder over the build platform 122. The transition from a solid phase to a liquid phase within the powdered material occurs substantially isothermally at the melting temperature of the material. Therefore, given the melting point of the material loaded into the apparatus 100, Block S112 can predict a temperature at the laser sintering site. For example, Block S112 can predict that the temperature at an interaction zone (i.e., the laser sintering site) between powdered material and the laser beam will approximate the melting temperature of the material with the temperature of adjacent powdered material diminishing radially outward from the interaction zone. Alternatively, Block S112 can predict a temperature at the laser sintering site that is 80% of the melting temperature of the material, a temperature that yields superficial melting at a surface of a grain of powdered material rather than complete transition of the grain of powdered material into the liquid state. Additionally or alternatively, by achieving 80% of the melting temperature of the material at the laser sintering site, enough activation energy to fuse adjacent grains of powdered can be achieved at the laser sintering site. Yet alternatively, Block S112 can retrieve the target fuse temperature from a part build file loaded into and/or stored on the apparatus 100. However, Block S112 can predict a fuse temperature or set a target temperature at the laser sintering site according to any other schema or material property.

Once the fuse temperature or target temperature at the laser sintering site is predicted and/or set, Block S112 can select a shutter speed corresponding to a range of detectable temperatures that includes the predicted fuse temperature (or the target fuse temperature) at the laser sintering site. In particular, a pixel in the image sensor 140 can have a maximum electron capacity (e.g., 1.8×10⁷ electrons), and the pixel can collect electrons as electromagnetic radiation (e.g., infrared light) is radiated from heated material at the laser sintering site. Once the pixel reaches its electron capacity, a specific temperature can no longer be correlated with the light intensity recorded by the pixel. Therefore, Block S112 can select a shutter speed for the image sensor 140 such that pixels capturing light corresponding to the laser sintering site capture more than a minimum number of electrons and less than a maximum number of electrons in their capacity range. For example, Block S112 can set the shutter speed of the image sensor 140 such that the target fuse temperature approximates a center temperature between a minimum temperature and a maximum temperature corresponding to a minimum number of electrons and a maximum number of electrons, respectively, collected by pixels in the image sensor 140 for the selected shutter speed. In this example, Block S112 can implement a lookup table, an algorithm, or any other parametric or non-parametric model to select the shutter speed for the image sensor 140 based on the predicted or target fuse temperature of the powdered material.

Block S112 can also set the shutter speed based on the emissivity of the powdered material. In particular, the magnitude of radiation of electromagnetic energy (e.g., photons) from the material at the laser sintering site can be quantified with the emissivity of the material. Therefore, a number of electrons collected by a pixel in the image sensor 140 for the same shutter speed and for the materials at the same temperature can be different across two materials with different emissivities, and Block S112 can therefore set the shutter speed based on the emissivity of the material. For example, Block S112 can set a faster shutter speed for a material with a higher emissivity and a slower shutter speed for a material with a lower emissivity.

In one implementation, Bock S112 applies a constant emissivity for the material to set the shutter rate, such as a constant emissivity based on the “gray body assumption.” Alternatively, Block S112 can calculate the emissivity of the material based on the predicted or target temperature of the material at the laser sintering site, a thickness of the powered material layer(s), an operating wavelength of the laser diode 132, and/or an angle of the image sensor 140 to the laser sintering site, etc. For example, Block S110 can download a parametric model of emissivity as a function of temperature, thickness, wavelength, and/or emission angle, and Block S112 can insert the predicted temperature at the laser sintering site into the model to calculate the emissivity of the material at the laser sintering site. Block S112 can also insert the actual or target wavelength of the laser diode 132 and a current position of the image sensor 140 relative to the laser sintering into the parametric model. For example, Block S112 can insert into the parametric emissivity model an emission angle based on a current angle between the laser output optic 130 on the actuator 124 relative to the static image sensor or a constant angle between the image sensor 140 and the output optic that are both fixed on the actuator 124. Block S112 can further insert a target thickness of each powdered material layer and/or an average grain diameter of the powdered material into the parametric model. However, Block S110 can download any other emissivity-related model, and Block S112 can calculate an emissivity of the material and set the shutter speed of the image sensor 140 accordingly in any other suitable way.

Block S110 can similarly function to set a shutter speed (or other parameter for image capture at the image sensor 140) based on an irradiation setting type for the laser sintering site. For example, if the build cycle current specifies a fusion (i.e., melting) cycle for the topmost layer of build material, Block S110 can set the shutter speed at 15 milliseconds, which corresponds to a relatively high temperate at the laser sintering site associated with melted build material. Alternatively, if the build cycle current specifies an anneal cycle for the topmost layer of build material, Block S110 can set the shutter speed at 25 milliseconds, which corresponds to a lower temperate at the laser sintering site associated with annealing previously-fused build material.

The laser sintering apparatus 100 can also simultaneously fuse build material at a first laser sintering site and anneal previously-fused build material at a second laser sintering site on the topmost layer of build material. In this variation, Block S110 can set the shutter speed (or other imaging parameter) at a speed supporting determination of material temperatures (e.g., maximum temperature, average temperature, and/or temperature gradient) at both the first laser sintering site and the second laser sintering site through analysis of a single image containing both the first and second laser sintering sites. Alternatively, for the laser sintering apparatus that substantially simultaneously fuses and anneals (discrete or overlapping) regions of the build material, Block S110 can set an image capture schedule that specifies two alternating shutter speeds, one supporting temperature detection at a “fuse” site and another supporting temperature detection at an “anneal” site. Block S130 can similarly set an image capture schedule that a cycle of three shutter speeds, one supporting temperature detection at a “fuse” site, another supporting temperature detection at an “anneal” site, and a third supporting capture of a photographic image of the topmost layer of build material.

### 2.3 Image Capture

Block S120 of the first method S100 recites, at a first time, capturing a first digital image of the laser sintering site with the image sensor 140 at a first shutter speed. Generally, Block S120 functions to trigger capture of a static digital image within the image sensor 140 executing the shutter speed set in Block S112. Once the image is captured, Block S120 can pass the image in digital form the Block S130 to temperature estimation in substantially real-time, or Block S130 can store the image for asynchronous (i.e., later) analysis.

Block S120 can continuously capture images of the laser sintering site (i.e., laser sintering sites as the laser moves across the topmost layer of powdered material), such as at a preset rate (e.g., five images per second), by initiating capture of a new image as soon as a previous image is downloaded from the image sensor 140, or according to a preset duty cycle (e.g., a duty cycle of 50%, that is, capturing of one image at the specified shutter speed followed by a pause equivalent to the shutter speed). Alternatively, Block S120 can capture images of the laser sintering site in response to an output from another sensor within the apparatus 100 and/or in response to a manual input into the apparatus 100, such as by an operator.

As shown in FIG. 2, one variation of the first method S100 includes Block S110, which recites, at a second time, capturing a second digital image with the image sensor 140 at a second shutter speed, the second shutter speed slower than the first shutter speed, and rendering the second image on a digital display coupled to the laser sintering device. Generally, Block S170 functions to capture a second image of the build chamber 120 with the image sensor 140 operating at a slower shutter speed such that the second image contains enough data to render (or store) a meaningful photographic image. For example, the first shutter second speed can be 15 milliseconds, which is adequate time to match a predicted temperature at the laser sintering site to electron capacity of the image sensor 140 pixels, and the second shutter speed can be 15 273 milliseconds, which is adequate time to collect radiation in the electromagnetic spectrum from around the laser sintering site. Block S170 can further store the second image (e.g., locally or on a remote database) for later access, or Block S170 can pass the image to Bock S162 for live or asynchronous rendering on a display arranged on the apparatus 100.

### 2.4 Temperature Feedback

Block S130 of the first method S100 recites, correlating a light intensity of a pixel within the first digital image with a first temperature at the laser sintering site at the first time based on the first shutter speed. Block S130 can similarly recite correlating a light intensity of a pixel within the first digital image with a first temperature at the laser sintering site at the first time based on the emissivity of the material and the first shutter speed. Generally, Block S130 functions to convert a number of electrons captured by one or a set of pixels in the digital image with a temperature of a corresponding area in or around the laser sintering site.

Block S130 can analyze the image on a per-pixel basis, thus converting a light intensity captured at each pixel into a corresponding temperature within the build chamber 120. Alternatively, Block S130 can group pixels. In this implementation, Block S130 can group pixels statically, such as by separating the rectilinear image into square arrays of pixels and correlating average image properties of each set of pixels within a single temperature. For example, Block S130 can group a ten-by-ten array of adjacent pixels, average the recorded light intensity (e.g., the number of electrons) captured by the pixels in the image, and convert the average recorded light intensity into a temperature across the corresponding area within the build chamber 120. Alternatively, Block S130 can dynamically group pixels in the image, such as by grouping pixels with substantially similar (e.g., ±2×10⁵ electrons) or identical recorded light intensities, and Block S130 can thus calculate a common temperature for each group of pixels with substantially similar or identical recorded light intensities. Block S130 can also analyze only pixels that correspond to the laser sintering site and to regions of the topmost layer of powdered material directly adjacent the laser sintering site (e.g., within a one-millimeter radius of the laser sintering site).

Block S130 can convert the light intensity recorded by one or a group of pixels in the image directly into a corresponding temperature. For example, Block S130 can pass a light intensity (e.g., a number of collected electrons) in a pixel into a generic lookup table or algorithm specific to the shutter speed to output a corresponding temperature. Alternatively, Block S110 can download or select a lookup table or algorithm specific to the shutter speed and specific to the material in the cartridge 190 based on data retrieved from the cartridge 190, and Block S130 can pass a light intensity of a pixel into the material-specific lookup table or algorithm to output a corresponding temperature.

Yet alternatively, Block S130 can pass an emissivity and/or a reflectivity value, an emissivity and/or reflectivity function (e.g., emissivity as a function of temperature, emission angle, wavelength, etc.), an emission angle (e.g., a position of the image sensor 140 relative to the laser sintering site or to an area within the build chamber 120 corresponding to the pixel at the time the image was captured), the wavelength of the laser diode 132 at the time the image was captured, a property of a light filter between the image sensor 140 and the laser sintering site or a light response of the image sensor 140, a thickness of the powdered material layer, and/or an average diameter of grains of the powdered material, etc. into an algorithm (e.g., a multi-order polynomial or a set of equations) to calculate the temperature at an area within the build chamber 120 corresponding to the pixel at the time the image was captured. In this implementation, the algorithm can be specific to the shutter speed, or the algorithm can be a function of the shutter speed, and Block S130 can thus pass the shutter speed into the algorithm to output a temperature. The algorithm can also be specific to the type of material in the build chamber 120, data that can be downloaded from the cartridge 190 or from a remote database in Block S110, or the algorithm can be generic to a group of materials (e.g., all metals, all ferrous alloys, etc.), stored locally on the apparatus 100, and/or selected based on a known material type in the cartridge 190 in Block S110.

Therefore, Block S130 can correlate light intensity recorded at one or more pixels with a first temperature at or near the laser sintering site based on the emissivity of the powdered material, a determined distance or angle between the image sensor 140 and the laser sintering site (e.g., a position of X-Y table 126 of the actuator 124), the shutter speed, and/or any other number of related factors or variables.

Block S130 can select a single or a group of pixels with a highest (average or composite) recorded light intensity and correlate this recorded light intensity with a single temperature. Block S130 can therefore calculate or estimate a highest temperature proximal the laser sintering site. Block S130 can further analyze pixels of lower light intensity, such as to generate a temperature map or to calculate a temperature gradient across an area of the material layer at or proximal the laser sintering site.

Block S130 can also identify multiple laser sintering sites within the image. For example, the laser sintering apparatus 100 can include multiple laser output optics that project discrete energy beams toward the topmost layer of powered material within the build chamber 120 during a fuse cycle, and Block S130 can analyze an image of the topmost layer of powdered material to detect a maximum temperature, average temperature, and/or temperature gradient across each of the discrete laser sintering sites. Block S130 can similarly simultaneously detect a maximum temperature, average temperature, and/or temperature gradient various annealing zones within the topmost layer of build material by analyzing a single image of the captured by the image sensor 140.

As shown in FIG. 2, one variation of the first method S100 further includes Block S162, which recites merging a portion of the first image corresponding to the laser sintering site with the second image to generate a composite image. Generally, Block S162 functions to display the second (e.g., photographic) image of the laser sintering site with temperature data corresponding to the same or similar laser sintering site. For example, Block S162 can merge the second (photographic) image with temperature data extracted from an immediately previous or an immediately subsequent image. In this example, the first method S100 can capture one photographic image before or after each temperature image captured at a faster shutter speed). Thus, a region of the build chamber 120 captured in a temperature-related image can be substantially similar or can substantially match a region of the build chamber 120 captured in the preceding or subsequent photographic image.

In one implementation, Block S162 overlays a maximum temperature and/or a set of calculated temperatures from a preceding or succeeding) image onto corresponding regions of the second image. Alternatively, Block S162 can overlay an infrared image with indicated temperatures over the photographic image captured in Block S170. Block S162 can thus render any of these composite images on one or more displays of the apparatus 100, such as in real-time, and/or store any of these composite images locally or remotely, such as on a remote database or remote server.

### 2.5 Temperature Feedback & Data Storage

As shown in FIG. 2, one variation of the first method S100 can include Block S140, which recites selecting a threshold minimum sintering temperature for the laser sintering build material and triggering an alarm in response to the first temperature falling below the threshold minimum sintering temperature. Block S140 can further recite selecting a threshold maximum sintering temperature for the laser sintering build material and terminating build of a corresponding part within the laser sintering device in response to the first temperature exceeding the threshold maximum sintering temperature. Generally, Block S140 functions to monitor estimated temperatures at the laser sintering site and to respond to estimated temperatures that fall outside of a preset or predefined range of a target temperature.

In various examples, Block S110 can download a target fuse temperature for the material in the cartridge 190, or Block S112 can set the target fuse temperature based on a melting temperature of the material and/or a grain size of the powdered material. In these examples, Block S140 can set a threshold maximum and minimum deviation from the target fuse temperature (e.g., a static ±3% of the target fuse temperature), a material-specific maximum and minimum deviation from the target fuse temperature (e.g., ±3% for aluminum and ±1% for stainless steel), or a part- or project-specific maximum and minimum deviation from the target fuse temperature (e.g., ±0.5% for turbine engine blades and ±5% for dental fixtures). Alternatively, Block S110 can download target fuse temperature range, or Block S140 can receive manual entry of a maximum and minimum deviation from the target fuse temperature, such as from an operator. Yet alternatively, the maximum and minimum deviation from the target fuse temperature can be specified in a part build file (or program) loaded into the apparatus 100, and Block S140 can identify and retrieve these data from the part build file.

As additional laser sintering site temperatures are calculated from subsequent images, Block S140 can compare new maximum calculated temperatures from the images to the target fuse temperature range. If a maximum calculated temperature falls outside of the target fuse temperature range, Block S140 can throw an alarm and stop construction of the part. Alternatively, if the maximum calculated temperature falls outside of the target fuse temperature range, Block S140 can store a flag specifying the over-temperature or under-temperature event including an absolute time of the event (e.g., a timestamp), a relative time of the event (e.g., from a part build start time), a location (e.g., X-, Y-, and Z-actuator positions) of the event within the part, the actual calculated temperature of the event, a series of previous and/or subsequent calculated maximum temperatures of adjacent laser sintering sites, the temperature-related image, and/or the corresponding photographic image, etc. For example, Block S140 can store this event and related data locally or remotely in a construction file specific to the part currently under construction within the apparatus 100. This part file can be later accessed to guide inspection, failure analysis, pricing (e.g., based on manufacture quality), etc. of the specific corresponding part unit. However, Block S140 can handle an over-temperature or an under-temperature event in any other suitable way.

Furthermore, as shown in FIG. 2, one variation of the first method S100 can include Block S180, which recites storing in memory the first temperature at the laser sintering site with a first timestamp, the first timestamp corresponding to a first build time of a part within the laser sintering device relative to capture of the first image (i.e., the first time). Blocks of the first method S100 can also, at a second time succeeding the first time, capture a second digital image at the first shutter speed with the image sensor 140 and correlate a light intensity of a pixel within the second digital image with a second temperature at the laser sintering site at the second time based on the emissivity of the laser sintering build material and the first shutter speed. Block S180 can then store in memory the second temperature at the laser sintering site with a second timestamp, the second timestamp corresponding to a second build time of the part relative to capture of the second image (i.e., the second time). Thus, in this variation, Block S180 can store additional temperature-related data generated during construction of a part within the apparatus 100.

For example, Block S180 can store (locally or remotely) each maximum calculated temperature at each imaged laser sintering site during the entirety of a part build cycle within the apparatus 100. Block S180 can also store notes, such as deviations from the target temperature, temperature gradients spanning outward from laser sintering sites, over-temperature or under-temperature events, relative or absolute timestamps for each image, original, filtered, or cropped images, etc. As described above, these data can later be accessed to guide inspection, failure analysis, pricing (e.g., based on manufacture quality), etc. of the specific corresponding part unit.

Block S180 can also store an image with an operation type associated with localized heating of a layer build material at the time the image was captured. For example, Block S180 can tag a first image captured during a melt or fuse cycle with a “fuse” callout, and Block S180 can tag a second image captured during an anneal cycle with an “anneal” callout. However, Block S180 can store any other data corresponding to a part build within the apparatus 100 in any other suitable way.

As shown in FIG. 2, one variation of the first method S100 further includes Block S160, which recites adjusting a power output of a laser directing a beam toward the laser sintering site based on the first temperature and a phase change temperature of the laser sintering build material. Generally, Block S160 implements feedback controls to adjust power output of the laser diode(s) based on maximum temperatures calculated from images of laser sintering sites during construction of the part. For example, Block S160 can implement a proportional-integral-derivative (PID) controller to modify a power output and/or a frequency output of the laser diode(s) to maintain maximum laser fusion site temperatures substantially near the target fusion temperature for the part and/or for the material in the build chamber 120.

Block S160 can additionally or alternatively implement feedback controls to adjust a size of the laser spot at an interaction zone of the topmost layer of powdered material on which the energy beam is projected based on temperature gradients of laser sintering sites calculated from images captured during construction of the part. For example, Block S160 implement a PID controller to adjust a focusing system of the laser output optic 130 to achieve a desired temperature gradient at laser sintering sites during construction of the part. However, Block S160 can function in any other way and modify any other parameter of the laser diodes, the laser output optic 130, etc. to substantially maintain target manufacturing specifications during construction of the part.

### 3. Second Method

As shown in FIG. 3, a second method for controlling construction of a part over a build platform within a laser sintering device including an opaque door configured to seal the build platform 122 within a build chamber can include: setting a lamp within the build chamber 120 to an off state in Block S210; detecting electromagnetic radiation within the build chamber 120 based on an output of an optical sensor within the build chamber 120 in Block S220; in response to detection of electromagnetic radiation above a threshold flux, interrupting construction of the part within the build chamber 120 in Block S230; in response to detection of electromagnetic radiation below the threshold flux, setting the lamp 152 to an on state to illuminate the build chamber 120 in Block S240; at an image sensor within the build chamber 120, capturing a digital image of the laser sintering site in Block S250; and rendering the digital image on a digital display arranged on an exterior surface of the laser sintering device in Block S260.

Generally, the method can be implemented by the lamp 152, the processor 160, the optical sensor 150, and the display 180 (etc.) of the apparatus 100 to measure for electromagnetic radiation leakage into—and therefore laser light leakage out of—the apparatus 100, to delay or stop part construction in response to detected laser light leakage, and to provide a virtual window into the build chamber 120 of the apparatus 100 during part construction, as described above.

### 3.1 Lamp States

Block S210 of the method recites setting a lamp within the build chamber 120 to an off state. Generally, Block S210 functions to turn off electromagnetic radiation sources within the build chamber 120 and/or within the greater housing of the apparatus 100 such that electromagnetic radiation subsequently detected by the optical sensor 150 can be correlated with light leakage into the housing 110.

In one implementation, Block S210 sets the lamp 152 to the off state in response to closure of the opaque door 112 such that Block S220 can detecting electromagnetic radiation within the build chamber 120 before construction of the part begins (e.g., before a build start command for the part is received, such as from an operator). Block S210 can additionally or alternatively (intermittently) interrupt (e.g., pause) construction of the part and to set the lamp 152 to the off state for subsequent detection of light leakage, as described above.

### 3.2 Electromagnetic Radiation Detection

Block S220 of the method recites detecting electromagnetic radiation within the build chamber 120 based on an output of an optical sensor within the build chamber 120. Generally, Block S220 function to analyze an output of one or more optical detectors within the apparatus 100 to detect electromagnetic radiation therein. For example, as described above, Block S220 can read an output of one or more photovoltaic cells, photodiodes, photomultiplier tubes, phototubes, phototransistors, or other photodetectors within the housing 110.

Alternatively, Block S220 can interface within one or more image sensors, such as a CMOS camera or a CCD camera, within the apparatus 100 to collect a set of digital images. In this implementation, Block S220 can set long exposure times (i.e., slow shutter speeds) for the image sensor(s) and identify light leakage into the apparatus 100 based on at least a threshold number of electrons collected in at least a threshold number of pixels in a single image output by the image sensor 140 while the lamp 152 is in the off state (and the laser sintering site(s) is substantially cool). For example, Block S220 can detect a flux of infrared light on a pixel of the optical sensor 150 over a preset period of time (e.g., five seconds) and then compare the flux of infrared light incident on the pixel to the threshold flux. In this example, the threshold flux can be greater than zero, such as to account for noise or drift in the optical sensor 150 and/or the image sensor 140, as described above, Furthermore, in the implementation, Block S220 can capture and analyze images output from the image sensor 140 arranged over an interior surface of the opaque door 112 and directed toward the laser sintering site, and Block S220 can also substantially simultaneously capture and analyze digital images output by a second image sensor 142 (e.g., the optical sensor 150 arranged within the build chamber 120 and directed toward the interior surface of the opaque door 112.

In the variation of the method in which part construction is intermittently paused to perform a (light) leak detection test, Block S220 can capture and analyze images from one or more image sensors and/or optical sensors pausing construction of the part for a period of time corresponding to a cooling period for a region of the part and/or loose powdered material proximal the laser sintering site. In particular, in this variation, the method can delay reading an output of image sensor and/or the optical sensor 150 until fused and loose powdered material within the build chamber 120 has cooled sufficiently that false positives of light leakage are not triggered due to radiation from heating material within the build chamber 120.

As shown in FIG. 3, one variation of the method can include Block S212, which recites setting to an on state a second lamp 152 arranged on an exterior surface of the housing 110 and configured to emit light toward an edge of the opaque door 112, wherein detecting electromagnetic radiation within the build chamber 120 can include detecting within the build chamber 120 light emitted from the second lamp 152. In this variation, Block S212 can set one or more lamps outside of the housing 110 to an on state to provide a controlled source of electromagnetic radiation for leakage detection into the apparatus 100, as described above. One a leak detection test is complete, Block S212 can return the exterior lamp(s) to an off state.

Finally, Block S230 of the method recites, in response to detection of electromagnetic radiation above a threshold flux, interrupting construction of the part within the build chamber 120. Generally, Block S230 function to postpone initiation of construction of the part and/or to pause further construction of the part in response to a positive light leakage test result. For example, Block S230 can trigger an interlock to prevent initiation of a build routine for the part. Block S230 can additionally or alternatively sound an audible and/or a visual alarm in response to a positive light leakage test. Block S230 can also transmit an alarm or notification to an external device, such as a mobile computing device carried by an operator or a computer network that manages and controls a set of laser sintering machines including the apparatus 100. However, Blocks S210, S220, S230, etc. can function in any other way to perform a light leakage test and to handle a positive light leakage test result.

### 3.3 Virtual Window

Block S240 of the method recites, in response to detection of electromagnetic radiation below the threshold flux, setting the lamp 152 to an on state to illuminate the build chamber 120. Generally, Block S240 functions to trigger construction of the part within the apparatus 100 and/or to resume part construction within the apparatus 100 in response to a negative light leakage test result. As part construction begins or resumes, Block 240 can switch the lamp 152 inside the build chamber 120 to an on state to support capture of a photographic image and/or a photographic video stream of the interior of the build chamber 120 in Block S250 such that Block S260 can render the image and/or video stream on a display outside of the housing 110 substantially in real-time to provide a virtual window into the build chamber 120. In particular, Block S240 sets the lamp 152 to the on state to illuminate the build housing for subsequent capture of photographic images of the contents of the build chamber 120.

Block S250 of the method recites, at an image sensor within the build chamber 120, capturing a digital image of the laser sintering site. Generally, Block S250 handles single-image or video stream output from the image sensor 140 coupled to the interior surface of the opaque door 112 and passes these images to Block S260.

Block S260 of the method recites rendering the digital image on a digital display arranged on an exterior surface of the laser sintering device. Generally, Block S260 functions to display substantially live images on the display 180 coupled to the exterior surface of the display 180 such that the display 180 mimics a transparent window into the build chamber 120. However, Block S250 can handle images or video streams from any other image sensor within the build chamber 120, and Block S250 can render any of these images or video stream independently or concurrently on one or more displays arranged on or coupled to the apparatus 100. For example, Block S250 can also capture a second digital image or a second video stream of the laser sintering site from a second image sensor 142 removed from the image sensor 140 within the build chamber 120, and Block S260 can render the second digital image or the second video stream on a second digital display arranged on another exterior portion of the apparatus 100. However, Blocks S240, S250, and S260 can cooperate in any other way to provide a virtual window through the opaque door 112 (and/or the housing 110) of the apparatus 100 into the build chamber 120.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of an apparatus, laser sintering device, user computer or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor 160, though any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method for controlling construction of a part over a build platform within a laser sintering device including an opaque door configured to seal the build platform within a build chamber, the method comprising:
setting a lamp within the build chamber to an off state;
detecting electromagnetic radiation within the build chamber based on an output of an optical sensor within the build chamber;
in response to detection of electromagnetic radiation above a threshold flux, interrupting construction of the part within the build chamber;
in response to detection of electromagnetic radiation below the threshold flux, setting the lamp to an on state to illuminate the build chamber;
at an image sensor within the build chamber, capturing a digital image of the laser sintering site; and
rendering the digital image on a digital display arranged on an exterior surface of the laser sintering device.

2. The method of claim 1, wherein setting the lamp to the off state comprises setting the lamp to the off state in response to closure of the opaque door, and wherein detecting electromagnetic radiation within the build chamber comprises analyzing a signal from a light sensor in response to receiving a build start command for the part.

3. The method of claim 1, wherein detecting electromagnetic radiation within the build chamber comprises capturing a set of digital images through a set of image sensors within the laser sintering device, the set of image sensors comprising the optical sensor and the image sensor, and analyzing the set of digital images to detect leakage of visible light into the build chamber.

4. The method of claim 3, wherein capturing the set of digital images comprises capturing a second digital image at the image sensor coupled to an interior surface of the opaque door and directed toward the laser sintering site and capturing a third digital image at the optical sensor arranged within the build chamber and directed toward the interior surface of the opaque door.

5. The method of claim 1, wherein detecting electromagnetic radiation within the build chamber comprises detecting a flux of infrared light on a pixel of the optical sensor over a preset period of time and comparing the flux of infrared light to the threshold flux.

6. The method of claim 1, wherein interrupting construction of the part comprises triggering an interlock to prevent initiation of a build routine for the part.

7. The method of claim 1, wherein rendering the digital image on the digital display comprises rendering the digital image on the digital display coupled to an exterior surface of the opaque door, and further comprising capturing a second digital image of the laser sintering site at a second image sensor removed from the image sensor within the build chamber and rendering the second digital image on a second digital display arranged on an exterior surface of the laser sintering device.

8. The method of claim 1, further comprising intermittently pausing construction of the part during operation of the laser sintering device, and wherein detecting electromagnetic radiation within the build chamber comprises detecting electromagnetic radiation within the build chamber after a period of time after pausing construction of the part, the period of time corresponding to a cooling period for a portion of the part proximal the laser sintering site.

9. The method of claim 8, further comprising resuming construction of the part within the laser sintering device in response to detection of electromagnetic radiation below the threshold flux.

10. The method of claim 1, further comprising setting to an on state a second lamp arranged on an exterior surface of the housing and configured to emit light toward an edge of the opaque door, wherein detecting electromagnetic radiation within the build chamber comprises detecting within the build chamber light emitted from the second lamp.

11. An apparatus for manufacturing, comprising:
a build chamber comprising a build platform;
an actuator arranged within the build chamber;
a laser output optic supported by the actuator and configured to communicate an energy beam toward a laser sintering site over the build platform;
a housing containing the build chamber, the actuator, and the laser output optic and defining an aperture into the build chamber;
an opaque door coupled to the housing and configured to close the aperture;
an image sensor arranged within the housing and directed toward the laser sintering site; and
a display arranged on an exterior surface of the opaque door and configured to render images output by the image sensor substantially in real-time.

12. The apparatus of claim 11, further comprising an optical sensor configured to detect electromagnetic radiation within the build chamber, and further comprising a processor configured to pause construction of a part within the build chamber in response to detection of electromagnetic radiation above a threshold flux after closure of the opaque door.

13. The apparatus of claim 12, wherein the processor is configured to trigger an audible alarm in response to detection of electromagnetic radiation above a threshold flux.

14. The apparatus of claim 12, further comprising a lamp configured to illuminate the build chamber in an on state during image capture by the image sensor and to transition to an off state during detection of electromagnetic radiation by the optical sensor.

15. The apparatus of claim 12, wherein the optical sensor is configured to detect leakage of ambient light into the build chamber.

16. The apparatus of claim 12, further comprising a lamp arranged on an exterior surface of the housing configured to emit light toward the aperture, wherein the optical sensor is configured to detect leakage of light from the lamp into the build chamber.

17. The apparatus of claim 11, further comprising a second an image sensor arranged within the housing, wherein the display is configured to cycle through images output by the image sensor and the second image sensor substantially in real-time.

18. The apparatus of claim 11, wherein the actuator comprises a mechanized linear X-Y table, wherein a position of the image sensor is fixed on the mechanized linear X-Y table relative to the laser output optic.

19. The apparatus of claim 11, wherein the opaque door is configured to obstruct transmission of laser light out of the build chamber in a closed position and to enable physical access to the build chamber through the aperture in an open position.

20. The apparatus of claim 11, wherein the image sensor comprises a charge-coupled device camera directed toward the laser sintering site, and wherein the laser output optic is configured to communicate an energy beam toward a powdered material dispensed onto the build platform to fuse the powdered material at the laser sintering site.
